(19) United States
(12) Patent Application Publication
(10) Pub. No.: US 2020/0258318 A1
(43) Pub. Date: Aug. 13, 2020

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventor: Jun ENDO, Nagoya-shi (JP)

(73) Assignee: TOYOTA JIDOSHA KABUSHIKI KAISHA, Toyota-shi (JP)

(21) Appl. No.: 16/748,933

(22) Filed: Jan. 22, 2020

(30) Foreign Application Priority Data
Feb. 8, 2019 (JP) 2019-021323

(51) Int. Cl. G07B 15/02; G06Q 30/02; G08G 1/14; G07C 5/00

(52) U.S. Cl. CPC G07B 15/02; G06Q 30/0223; G08G 1/142; G07C 5/008; G08G 1/146

(57) ABSTRACT

An information processing apparatus according to an embodiment of the disclosure includes a ticket issuance control unit configured to inform a user who desires to use a parking lot having a plurality of parking spaces, of a candidate to be used as a parking place from among the plurality of parking spaces through an entrance machine, and a coupon activation unit configured to, when a vehicle of the user is parked in a parking space corresponding to the candidate to be used as a parking place, activate a coupon that is provided on a parking ticket issued to the user.

### INCORPORATION BY REFERENCE

The disclosure of Japanese Patent Application No. 2019-021323 filed on Feb. 8, 2019 including the specification, drawings and abstract is incorporated herein by reference in its entirety.

### BACKGROUND

### 1. Technical Field

The disclosure relates to an information processing apparatus, an information processing method, and a program.

### 2. Description of Related Art

For example, a technology for operating a parking lot whose parking fee is increased or reduced according to a parking position in the parking lot is known (see Japanese Unexamined Patent Application Publication No. 2002-236948 (JP 2002-236948 A)).

With such a technology, for example, as a vehicle is parked in a parking space farther from the entrance of a parking lot, the parking fee is lowered. Thus, the technology is able to facilitate usage of a parking lot not only places near the entrance but also places relatively far from the entrance.

### SUMMARY

However, even when the above technology is applied, the occupation of parking spaces may concentrate on part of a parking lot. This is because, for example, users are classified into users who give a higher priority to low parking fee and users who give a higher priority to convenience, users who give a higher priority to low parking fee can concentrate on parking positions that charge low parking fees; whereas users who give a higher priority to convenience can concentrate on parking positions that are highly convenient. For example, vehicles can stay in a parking lot because of congestion in part of the parking lot, and time required for parking extends. Thus, user's convenience can be decreased.

In light of the above inconvenience, it is an object to provide an information processing apparatus, an information processing method, and a program, that are able to further relieve congestion in a parking lot.

To achieve the above object, an embodiment of the disclosure provides an information processing apparatus. The information processing apparatus includes an informing unit configured to inform a user, who desires to use a parking lot having a plurality of parking spaces, of a candidate to be used as a parking place from among the plurality of parking spaces through a predetermined informing device, and an incentive provision unit configured to, when a vehicle of the user is parked in a parking space corresponding to the candidate to be used as a parking place, execute a process for providing a predetermined incentive to the user.

According to this embodiment, the information processing apparatus is able to guide a vehicle of a user to a parking space corresponding to a candidate to be used as a parking place with a relatively high probability as a result of an advantage of provision of an incentive. Therefore, the information processing apparatus is able to further relieve congestion in a parking lot by, for example, determining a candidate to be used as a parking place, of which the user is informed, in consideration of a status of congestion in a parking lot as a whole, or the like.

In the above embodiment, the candidate to be used as a parking place may be determined based on a status of vacancy of the plurality of parking spaces.

According to this embodiment, the information processing apparatus is able to specifically keep track of a status of congestion in a parking lot as a whole based on a status of vacancy of a plurality of parking spaces and inform a user of a candidate to be used as a parking place according to the status of congestion in the parking lot as a whole.

In the above embodiment, the candidate to be used as a parking place may be determined based on a status of congestion of vehicles moving in the parking lot.

According to this embodiment the information processing apparatus is able to specifically keep track of a status of congestion in a parking lot as a whole based on a status of congestion of vehicles moving in the parking lot and inform a user of a candidate to be used as a parking place according to the status of congestion in the parking lot as a whole.

In the above embodiment, the candidate to be used as a parking place may be determined based on at least one of the number, gender, and age of occupants in the vehicle of the user.

According to this embodiment, the information processing apparatus is able to, for example, when the number of occupants in a vehicle is relatively large, inform a user of a candidate to be used as a parking place such that the candidate to be used as a parking place is relatively close to an exit for people from a parking lot. This is because many people moving in a parking lot cause congestion of moving vehicles and relatively increase safety risks. The information processing apparatus is able to, for example, inform a user of a different candidate to be used as a parking place between when the ratio of women in occupants is relatively high and when the ratio of men in occupants is relatively high. This is because, for example, in the case of a parking lot of a facility, such as a shopping mall, destinations in the facility of women users are mostly different from destinations in the facility of men users. The information processing apparatus is able to, for example, when occupants include an infant or an elderly person, inform a user of a candidate to be used as a parking place such that the candidate to be used as a parking place is relatively close to an exit for people from a parking lot or an entrance of a facility with the parking lot. Thus, the information processing apparatus is able to further improve the convenience of a user.

In the above embodiment, the predetermined incentive may be determined such that details of the predetermined incentive in a case where a distance from the candidate to be used as a parking place to at least one of an entrance of the parking lot, an exit of the parking lot, and an entrance of a facility with the parking lot is relatively short is different from details of the predetermined incentive in a case where the distance is relatively long.

According to this embodiment, even when the information processing apparatus guides a vehicle of a user to a parking place whose distance from an entrance or exit of a parking lot, an entrance of a facility with the parking lot, or the like, is relatively long, a sense of unfairness that the user feels is reduced.

In the above embodiment, details of the predetermined incentive may be determined based on at least one of the number, gender, and age of occupants of the vehicle of the user.

According to this embodiment, the information processing apparatus is able to prepare an incentive to a user such that an advantage of a guide to a designated parking space to be informed to a user relatively increases according to the number, gender, age, or the like, of occupants in a vehicle of the user. Thus, the information processing apparatus is able to further relieve congestion in a parking lot.

In the above embodiment, the incentive provision unit may be configured to activate a predetermined coupon into an available state as the predetermined incentive, the predetermined coupon being provided on a parking ticket that is issued at an entrance of the parking lot, cause a user terminal of the user to display a predetermined coupon as the predetermined incentive, or add reward points as the predetermined incentive to a reward point balance of a predetermined reward point program, associated with user identification information of the user.

According to this embodiment, the information processing apparatus is able to specifically provide an incentive to a user.

Another embodiment of the disclosure may be implemented as an information processing method or a program.

According to the above embodiments, the information processing apparatus, the information processing method, and the program, that are able to further relieve congestion in a parking lot can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram that shows an example of the configuration of a parking lot management system;

FIG. 2 is a diagram that shows an example of the hardware configuration of a parking lot management server;

FIG. 3 is a functional block diagram that shows an example of the functional configuration of the parking lot management system; and

FIG. 4 is a flowchart that schematically shows an example of an entry process that the parking lot management server executes.

### DETAILED DESCRIPTION OF EMBODIMENTS

Hereinafter, an embodiment of the disclosure will be described with reference to the accompanying drawings.

### Outline of Parking Lot Management System

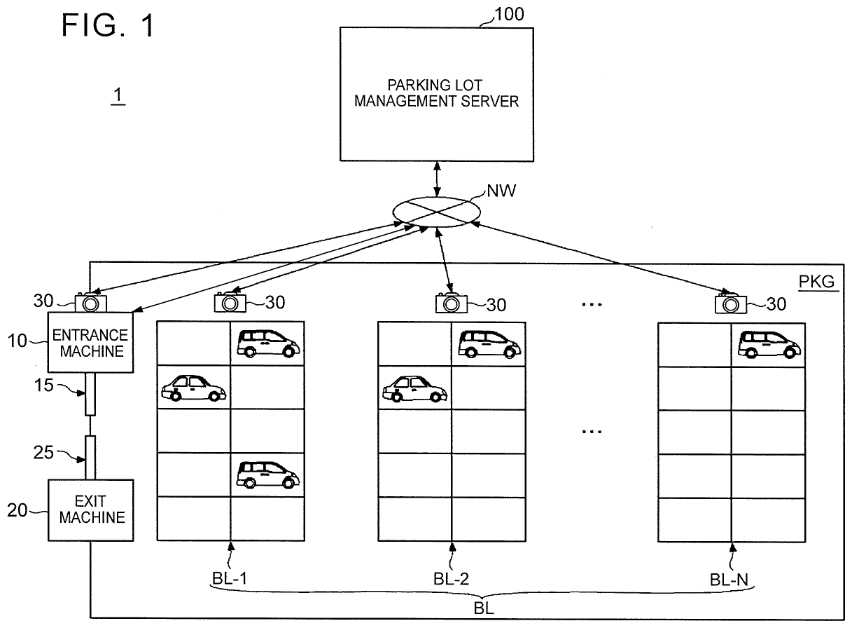

First, the outline of a parking lot management system 1 according to the embodiment will be described with reference to FIG. 1.

The parking lot management system 1 includes an entrance machine 10, an exit machine 20, a plurality of cameras 30, and a parking lot management server 100.

The parking lot management system 1 controls devices installed in a parking lot PKG, such as the entrance machine 10, the exit machine 20, and the cameras 30, and manages the parking lot PKG on the parking lot management server 100. The parking lot PKG to be managed by the parking lot management system 1 has a plurality of parking spaces. A plurality (in this embodiment, N (an integer greater than or equal to two)) of parking blocks BL (parking blocks BL-1, BL-2, . . . , BL-N) each made up of a parking space group (in this embodiment, a group of ten parking spaces) is provided in the parking lot PKG. For example, in FIG. 1, ten parking spaces are provided for each parking block BL.

The entrance machine 10 is provided at the entrance (entrance gate 15) of the parking lot PKG. The entrance machine 10 is communicably connected to the parking lot management server 100 via a predetermined communication network NW.

The entrance machine 10 issues a parking ticket to a user who desires to use the parking lot PKG, that is, a user who has come in front of the entrance gate 15 by vehicle, under control of the parking lot management server 100. The communication network NW can include, for example, a local area network (LAN), a mobile communication network including base stations as terminals, a communication satellite network that uses a communication satellite, and a wide area network (WAN), such as the Internet.

The exit machine 20 is provided at the exit (exit gate 25) of the parking lot PKG. The exit machine 20 is communicably connected to the parking lot management server 100 via the communication network NW. The exit machine 20, for example, adjusts the parking fee associated with a vehicle that desires to exit from the parking lot PKG, that is, a vehicle that has come in front of the exit gate 25 and opens or closes the exit gate 25 based on completion of the adjustment.

The cameras 30 are placed in the parking lot PKG in a distributed manner and are used to monitor the status of the parking lot PKG. The cameras 30 are communicably connected to the parking lot management server 100 via the communication network NW. The cameras 30 each capture an image in a prescribed capture range at predetermined intervals (for example, intervals of 1/30 seconds) and send (upload) the acquired captured image to the parking lot management server 100.

For example, one of the cameras 30 is provided near the entrance (entrance gate 15) of the parking lot PKG together with the entrance machine 10, and captures the image of a vehicle of a user who has come in front of the entrance gate 15 to use the parking lot PKG. The camera 30 is provided for each of the parking blocks BL-1, BL-2, . . . , BL-N. Each camera 30 captures the scene of the associated one of the parking blocks BL-1, BL-2, . . . , BL-N and the scene of its surrounding drive aisles.

The parking lot management server 100 (an example of an information processing apparatus) is communicably connected to various devices installed in the parking lot PKG, such as the entrance machine 10, the exit machine 20, and the cameras 30, through the communication network NW. The parking lot management server 100 may be installed in a place relatively close to the parking lot PKG (for example, an office of a facility, such as a shopping mall, with the parking lot PKG or may be installed in a remote place relatively distant from the parking lot PKG (for example, a management center that manages a plurality of parking lots including the parking lot PKG). The parking lot management server 100 understands the status of congestion of the parking lot PKG (such as the status of vacancy of parking spaces and the status of congestion of surrounding vehicles moving on drive aisles) from images captured by the cameras 30 respectively installed near the parking blocks BL-1, BL-2, . . . , BL-N. The parking lot management server 100, in consideration of the status of congestion of the parking lot PKG, guides a vehicle that desires to use the parking lot PKG to a designated parking space through the entrance machine 10 to relieve congestion of the parking lot PKG. The details will be described later.

### [Configuration of Parking Lot Management System]

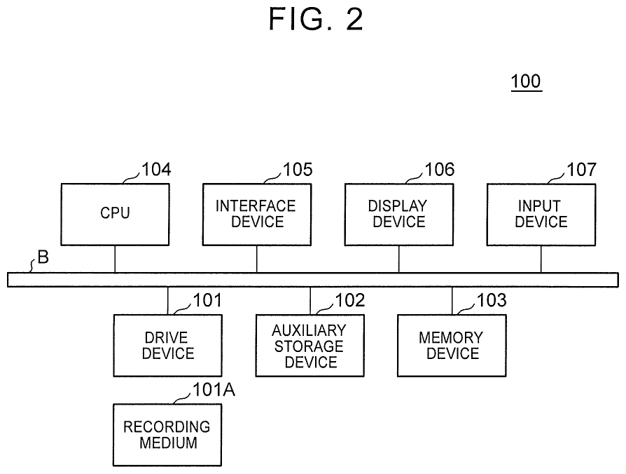

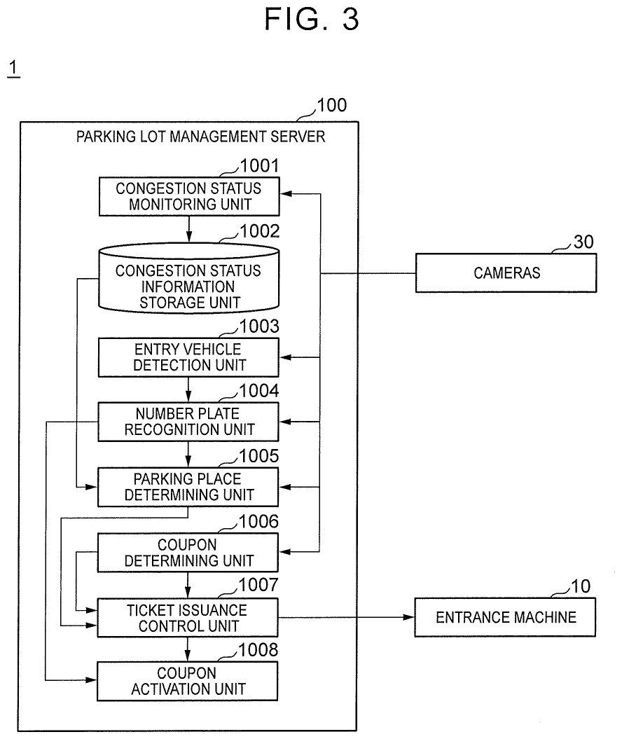

Next, the configuration of the parking lot management system 1 will be described with reference to FIG. 2 and FIG. 3 in addition to FIG. 1.

FIG. 2 is a diagram that shows an example of the hardware configuration of the parking lot management server 100. FIG. 3 is a functional block diagram that shows an example of the functional configuration of the parking lot management system 1.

The functions of the parking lot management server 100 may be implemented by any hardware or a combination of hardware and software. As shown in FIG. 2, for example, the parking lot management server 100 includes a drive device 101, an auxiliary storage device 102, a memory device 103, a CPU 104, an interface device 105, a display device 106, and an input device 107, which are connected to one another by a bus B.

Programs that implement the various functions of the parking lot management server 100 are provided by a portable recording medium 101A, such as a compact disc read only memory (CD-ROM), a digital versatile disc read only memory (DVD-ROM), and a universal serial bus (USB). As the recording medium 101A on which the programs are recorded is loaded in the drive device 101, the programs are installed from the recording medium 101A to the auxiliary storage device 102 via the drive device 101. The programs may be downloaded from another computer via a communication network and installed into the auxiliary storage device 102.

The auxiliary storage device 102 stores various installed programs and stores necessary files, data, and the like.

As the memory device 103 receives an instruction to launch a program, the memory device 103 reads the program from the auxiliary storage device 102 and stores the program.

The CPU 104 runs various programs stored in the memory device 103 to implement various functions of the parking lot management server 100 in accordance with the programs.

The interface device 105 is used as an interface for connection to a communication network (for example, the communication network NW).

The display device 106, for example, displays graphical user interface (GUI) in accordance with a program that the CPU 104 runs.

The input device 107 is used to allow an operator, an administrator, or the like, of the parking lot management server 100 to input various operation instructions on the parking lot management server 100.

As shown in FIG. 3, the parking lot management server 100 includes, for example, a congestion status monitoring unit 1001, an entry vehicle detection unit 1003, a number plate recognition unit 1004, a parking place determining unit 1005, a coupon determining unit 1006, a ticket issuance control unit 1007, and a coupon activation unit 1008 as functional units to be implemented by running one or more programs installed in the auxiliary storage device 102 on the CPU 104. The parking lot management server 100 uses a congestion status information storage unit 1002, and the like. The congestion status information storage unit 1002 can be implemented by using, for example, the auxiliary storage device 102 or an external storage device communicably connected to the parking lot management server 100.

The congestion status monitoring unit 1001 periodically (for example, every 15 minutes) acquires the current status of congestion in the parking lot PKG or predicts the future status of congestion based on images captured by the cameras 30 and outputs information about the current status of congestion or the future status of congestion (hereinafter, congestion status information).

For example, the congestion status monitoring unit 1001 may recognize the status of vacancy of the parking spaces of the parking blocks BL-1, BL2, . . . , BL-N or predict the future status of vacancy based on images captured by the cameras 30 by applying a known image processing technology. The congestion status monitoring unit 1001 may output information about the current status of vacancy of the parking spaces or the future status of vacancy of the parking spaces (hereinafter, vacancy status information).

The congestion status monitoring unit 1001 may recognize the current status of congestion of vehicles (hereinafter, moving vehicles) moving on drive aisles around the parking blocks BL-1, BL-2, . . . , BL-N (for example, near which parking block BL moving vehicles are stagnating on drive aisles) or predict the future status of congestion based on images captured by the cameras 30 by applying a known image processing technology. The congestion status monitoring unit 1001 may output information about the current status of congestion of moving vehicles or the future status of congestion of moving vehicles (hereinafter, moving congestion status information).

Congestion status information (vacancy status information and moving congestion status information) that is output from the congestion status monitoring unit 1001 is stored in the congestion status information storage unit 1002. Specifically, the latest congestion status information is stored in the congestion status information storage unit 1002. A history of past congestion status information may be stored in congestion status information. With this configuration, for example, the congestion status monitoring unit 1001 is able to predict the future status of congestion in the parking lot PKG by consulting the history of past congestion status information.

The entry vehicle detection unit 1003 detects a vehicle of a user who desires to use the parking lot PKG, that is, a vehicle that has come in front of the entrance (entrance gate 15) of the parking lot PKG, based on an image captured by the camera 30 near the entrance (entrance gate 15) of the parking lot PKG.

The number plate recognition unit 1004 recognizes the number plate of a vehicle in captured images and the details (specifically, a combination of numerals, characters, symbols, and the like) of the number plate based on the images captured by the cameras 30 by applying a known image processing technology.

For example, the number plate recognition unit 1004 recognizes the number plate of a vehicle that enters from the entrance (entrance gate 15) of the parking lot PKG into the parking lot PKG and the details of the number plate based on an image captured by the camera 30 near the entrance (entrance gate 15) of the parking lot PKG.

The number plate recognition unit 1004 (an example of an identifying unit) recognizes the number plate of a vehicle parked in each parking space and the details of the number plate based on an image captured by the camera 30 installed for each of the parking blocks BL-1, BL-2, . . . , BL-N. The number plate recognition unit 1004 determines which parking space a vehicle that has entered from the entrance (entrance gate 15) of the parking lot PKG is parked.

The parking lot management server 100 may determine which parking space a vehicle that has entered from the entrance (entrance gate 15) of the parking lot PKG is parked, with a method other than the method using images captured by the cameras 30. For example, the parking lot management server 100 may determine which parking space a vehicle that has entered is parked, with a bar code reader, an IC card reader, or the like, installed for each of the parking blocks BL-1, BL-2, . . . , BL-N of the parking lot PKG. In this case, the parking lot management server 100 is able to identify a parking space (parking block BL) at which a vehicle of a user is parked, by the user placing a bar code of a parking ticket over the bar code reader of the parking block BL associated with a candidate(s) to be used as a parking place or the user placing, for example, a predetermined IC card unique to the user or a predetermined smartphone incorporating an IC chip unique to the user, over an IC card reader.

The parking place determining unit 1005 determines a candidate parking place(s) (hereinafter, candidate(s) to be used as a parking place) to prompt a user who desires to use the parking lot PKG, that is, a vehicle that has come in front of the entrance (entrance gate 15) of the parking lot PKG, from among the plurality of parking spaces based on the congestion status information in the congestion status information storage unit 1002. A candidate(s) to be used as a parking place may be one parking space or may be a plurality of parking spaces. When the candidate(s) to be used as a parking place is/are a plurality of parking spaces, the candidates may be a designated parking block BL of the parking blocks BL-1, BL-2, . . . , BL-N. Alternatively, a candidate(s) to be used as a parking place may be one parking space.

For example, the parking place determining unit 1005 extracts a parking block(s) whose degree of congestion is low among the parking blocks BL-1, BL-2, . . . , BL-N (for example, a parking block(s) BL whose parking spaces are relatively vacant or a parking block(s) BL around which the number of vehicles stagnating on surrounding drive aisles is relatively small) based on the congestion status information. The parking place determining unit 1005 may determine a candidate(s) to be used as a parking place from among the parking spaces of the extracted parking block(s) BL. At this time, the parking place determining unit 1005, in consideration of the future status of vacancy of parking spaces to be predicted among the parking blocks BL-1, BL-2, . . . , BL-N or the status of congestion on surrounding drive aisles, may extract a parking block(s) BL whose state of vacancy of parking spaces or whose state of less vehicles stagnating on drive aisles is predicted to continue in the future. With this configuration, the parking lot management server 100 is able to guide a vehicle to a relatively vacant parking block(s) BL, so the parking lot management server 100 is able to relieve congestion in a parking lot.

The parking place determining unit 1005 may determine a candidate(s) to be used as a parking place based on the number and attribute information (for example, gender, age, and the like) of occupants in a vehicle that has come in front of the entrance (entrance gate 15) of the parking lot PKG.

Specifically, the parking place determining unit 1005 may determine a candidate(s) to be used as a parking place such that the candidate(s) is/are closer to an exit for people from the parking lot PKG as the number of occupants increases. This is because many people moving in a parking lot cause congestion of moving vehicles and relatively increase safety risks.

The parking place determining unit 1005 may, when the ratio of persons per gender in occupants (hereinafter, gender ratio) is relatively significantly unbalanced to a men side or a women side, differentiate a candidate(s) to be used as a parking place between when the gender ratio is unbalanced to a women side and when the gender ratio is unbalanced to a men side. Specifically, when the parking lot PKG is provided next to a shopping mall, or the like, the parking place determining unit 1005 may determine a candidate(s) to be used as a parking place such that the candidate) is/are relatively close to a shop or facility intended for women of a shopping mall, or the like, when the gender ratio of occupants in a vehicle is relatively significantly unbalanced to a women side. The parking place determining unit 1005 may determine a candidate(s) to be used as a parking place such that the candidate(s) is/are relatively close to a shop or facility intended for men of a shopping mall, or the like, when the gender ratio of occupants in a vehicle is relatively significantly unbalanced to a men side. With this configuration, the parking lot management server 100 is able to guide a vehicle to a candidate(s) to be used as a parking place for genders of occupants.

The parking place determining unit 1005 may, when an occupant of very low age (for example, an infant, a child, or the like) or an occupant of very high age (for example, an elderly person, or the like) is in a vehicle, determine a candidate(s) to be used as a parking place such that the candidate(s) is/are relatively close to an exit for people from the parking lot PKG or the entrance of a facility, such as a shopping mall, with the parking lot PKG. For example, the parking place determining unit 1005 classifies an occupant into four age categories, that is, “Infant” under six, “Child” six or over and under 15, “Adult” 15 or over and under 65, and “Elderly” 65 or over, and assigns different scores for each age category (for example, 5 for “Infant”, 2 for “Child”, 1 for “Adult”, and 3 for “Elderly”). The parking place determining unit 1005 may calculate the average of the scores of all the occupants (for example, when occupants of a vehicle include one person as “Infant”, three persons as “Adult”, and one person as “Elderly”, (5+3×1+3)/5=2.2), and determine a candidate(s) to be used as a parking place such that the candidate(s) is/are relatively close to an exit for people from the parking lot PKG or the entrance of a facility, such as a shopping mall, with the parking lot PKG as the average increases.

The number, gender, age, and the like, of occupants in a vehicle are recognized based on captured images including a cabin of the vehicle, which are acquired by the cameras 30, by applying a known method (for example, see Japanese Unexamined Patent Application Publication No. 2012-252507 (JP 2012-252507 A), Japanese Unexamined Patent Application Publication No. 6-333023 (JP 6-333023 A), or the like).

The parking place determining unit 1005 may determine a candidate(s) to be used as a parking place by combining the above-described plurality of elements. For example, when an average based on the above-described age categories is greater than or equal to a predetermined threshold, the parking place determining unit 1005 selects a parking block(s) BL whose degree of congestion is relatively low from among the parking blocks BL relatively close to an exit for people from the parking lot PKG or the entrance of a facility, such as a shopping mall, with the parking lot PKG, and determines the parking block(s) BL as a candidate(s) to be used as a parking place. On the other hand, when an average based on the above-described age categories is less than the predetermined threshold, the parking place determining unit 1005 selects a parking block(s) BL whose degree of congestion is relatively low from the entire parking lot PKG, that is, from among all the parking blocks BL-1, BL-2, . . . , BL-N, and determines the parking block(s) BL as a candidate(s) to be used as a parking place.

The coupon determining unit 1006 determines the details of a coupon as an incentive to a user who desires to use the parking lot PKG for parking a vehicle at a candidate(s) to be used as a parking place. For example, the coupon determining unit 1006 may determine the details of a coupon by selecting a coupon from among a plurality of coupons prepared in advance. A coupon may be a coupon available at an actual shop (for example, a coupon available when shown to a staff at an actual shop) or a coupon available on an electronic commerce (EC) site, or the like (for example, a coupon available when a code, or the like, is input on an EC site).

For example, the coupon determining unit 1006 determines the details of a coupon according to a candidate(s) to be used as a parking place. Specifically, the coupon determining unit 1006 may differentiate the details (type) of a coupon between when a candidate(s) to be used as a parking place is/are relatively close to the entrance (entrance gate 15) or exit (exit gate 25) of the parking lot PKG and when a candidate(s) to be used as a parking place is/are relatively far from the entrance (entrance gate 15) or exit (exit gate 25) of the parking lot PKG. With this configuration, the parking lot management server 100 is able to provide a coupon that can make a user who uses a candidate(s) to be used as a parking place relatively far from the entrance (entrance gate 15) or exit (exit gate 25) of the parking lot PKG feel more valuable. Thus, the parking lot management server 100 is able to reduce a sense of unfairness that a user feels from a difference in a candidate(s) to be used as a parking place for each user.

The coupon determining unit 1006 may determine the details of a coupon according to the number of occupants in a vehicle, attribute information (for example, gender and age) of occupants, or the like.

Specifically, the coupon determining unit 1006 may determine the details (type) of a coupon such that the number of persons to which a coupon is applicable is greater than or equal to the number of occupants. This is because, depending on the type of a coupon, the number of applicable persons can be limited.

The coupon determining unit 1006 may select a coupon intended for women from among a plurality of coupons prepared in advance when the gender ratio of occupants is relatively significantly unbalanced to a women side, and select a coupon intended for men when the gender ratio is relatively significantly unbalanced to a men side.

When occupants in a vehicle are young, when occupants in a vehicle are middle aged, or when occupants in a vehicle are elderly, the coupon determining unit 1006 may select a coupon adapted to the age from among a plurality of coupons prepared in advance.

The coupon determining unit 1006 may determine the details of a coupon according to a class of composition of a combination of the number, gender, and age of occupants in a vehicle (for example, “family”, “one young person”, “middle-aged persons of the same gender”, “elderly couple”, or the like).

The ticket issuance control unit 1007 (an example of an informing unit), when a vehicle has been detected by the entry vehicle detection unit 1003 in a situation in which there is/are a vacant parking space(s) in the parking lot PKG, sends a control instruction to the entrance machine 10 to issue a parking ticket and inform a user of a candidate(s) to be used as a parking place by voice. Specifically, the ticket issuance control unit 1007 causes the entrance machine 10 to issue a parking ticket on which the details of a coupon, which is determined by the coupon determining unit 1006, are provided (printed). The ticket issuance control unit 1007 causes the entrance machine 10 to inform a user that a coupon on a parking ticket is available, that is, activated, when a candidate(s) to be used as a parking place is/are used, together with information about the candidate(s) to be used as a parking place.

The coupon activation unit 1008 (an example of an incentive provision unit), when a vehicle of a user is parked in a parking space corresponding to a candidate(s) to be used as a parking place, executes a process for providing a coupon as an incentive to the user. Specifically, the coupon activation unit 1008 activates a coupon of a parking ticket such that the coupon is actually available. For example, the coupon activation unit 1008 may activate a coupon into an available state by accessing through the communication network NW a server device of a point-of-sale (POS) system at a shop where the coupon is used and instructing the server device to enter a unique code, or the like, assigned to the coupon.

A candidate(s) to be used as a parking place can be occupied by a vehicle of another user or vehicles of other users. In this case, the coupon activation unit 1008 may, for example, activate a coupon when a vehicle of a user is parked in a parking space that is farther from the entrance (entrance gate 15) of the parking lot PKG than an informed candidate(s) to be used as a parking place.

Specific Example of Process that Parking Lot Management Server Executes

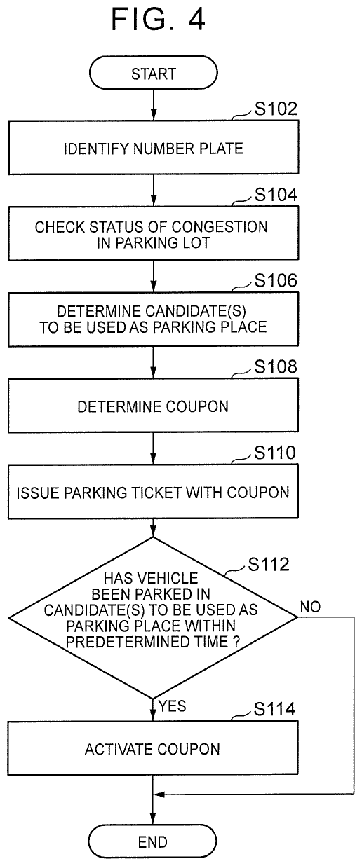

Next, a process at the time of entry of a vehicle into the parking lot PKG (hereinafter, entry process), which the parking lot management server 100 executes, will be described with reference to FIG. 4.

FIG. 4 is a flowchart that schematically shows an example of the entry process that the parking lot management server 100 executes. This flowchart is started when a vehicle that has come in front of the entrance (entrance gate 15) of the parking lot PKG (hereinafter, entry vehicle) has been detected by the entry vehicle detection unit 1003.

In step S102, the number plate recognition unit 1004 recognizes the details of the number plate of the entry vehicle based on an image captured by the camera 30 near the entrance of the parking lot PKG, and then the process proceeds to step S104.

In step S104, the parking place determining unit 1005 checks the current status of congestion and predicted future status of congestion in the parking lot PKG based on congestion status information in the congestion status information storage unit 1002, and then the process proceeds to step S106.

In step S106, the parking place determining unit 1005 determines a candidate(s) to be used as a parking place based on the current status of congestion and predicted future status of congestion in the parking lot PKG, and other information, and then the process proceeds to step S108.

In step S108, the coupon determining unit 1006 determines a coupon (specifically, the details of a coupon) based on the determined candidate(s) to be used as a parking place and the number, attribute information, and the like, of occupants in the entry vehicle.

In step S110, the ticket issuance control unit 1007 sends a control instruction to the entrance machine 10 to cause the entrance machine 10 to issue a parking ticket on which a coupon is provided (printed) and to inform a user of the entry vehicle of the candidate(s) to be used as a parking place, and the like, by voice. With this configuration, the entrance machine 10 issues a parking ticket with a coupon and also informs the user of the entry vehicle by voice of the candidate(s) to be used as a parking place and information that the coupon is activated when the candidate(s) to be used as a parking place is used. For example, the entrance machine 10 outputs voice “Please park your vehicle in any parking space of Block XX. When you park your vehicle in Block XX, give you a coupon for YYY coffee.” With this configuration, the user of the entry vehicle is able to recognize the candidate(s) to be used as a parking place and is able to recognize that the coupon can be available when the entry vehicle is parked in the candidate(s) to be used as a parking place. The ticket issuance control unit 1007 may cause the entrance machine 10 to inform the user of the entry vehicle of the candidate(s) to be used as a parking place, and the like, with display on a display device (for example, a liquid crystal display, or the like) instead of or in addition to voice.

In step S112, the coupon activation unit 1008 determines whether the number plate recognition unit 1004 has identified within a predetermined time the entry vehicle parked in a parking space corresponding to the candidate(s) to be used as a parking place. The predetermined time may be set to a value longer than the maximum value of a time that is assumed to be taken by the entry vehicle to park the candidate(s) to be used as a parking place. The predetermined time may be constant or may be variable in consideration of the status of congestion in the parking lot PKG, a distance from the entrance to the candidate(s) to be used as a parking place, or the like. When the number plate recognition unit 1004 has identified within the predetermined time the entry vehicle parked in a parking space corresponding to the candidate(s) to be used as a parking place, the coupon activation unit 1008 proceeds to step S114; otherwise, the coupon activation unit 1008 ends the current process.

In step S114, the coupon activation unit 1008 activates the coupon printed on the issued parking ticket and ends the current process.

### Operation of Present Embodiment

Next, the operation of the parking lot management system (parking lot management server 100) according to the present embodiment will be described.

In the present embodiment, the ticket issuance control unit 1007 informs a user, who desires to use a parking lot having a plurality of parking spaces, of a candidate(s) to be used as a parking place selected from among the plurality of parking spaces through a predetermined informing device (entrance machine 10). The coupon activation unit 1008, when a vehicle of the user is parked in a parking space corresponding to the candidate(s) to be used as a parking place, executes a process for providing a predetermined incentive to the user.

With this configuration, the parking lot management server 100 is able to guide a vehicle of a user to a parking space corresponding to a candidate(s) to be used as a parking place with a relatively high probability as a result of an advantage of provision of an incentive. Therefore, the parking lot management server 100 is able to further relieve congestion in a parking lot by, for example, determining a candidate(s) to be used as a parking place, of which the user is informed, in consideration of the status of congestion in the parking lot as a whole, or the like.

A candidate(s) to be used as a parking place may be informed to a user through an informing device other than the entrance machine 10. For example, a candidate(s) to be used as a parking place may be informed to a user of a vehicle through a mobile terminal, such as a smartphone, tablet terminal, and a laptop computer terminal, carried by the user. Alternatively, for example, when reservations for parking lots are available through the Internet, a candidate(s) to be used as a parking place may be informed to a user through a desktop computer terminal at user's home, or the like. In other words, a candidate(s) to be used as a parking place may be informed to a user who desires to use a parking lot through a user terminal of the user. In this case, for example, through an application program preinstalled in a user terminal to assist in using a parking lot, the parking lot management server 100 may inform a candidate(s) to be used as a parking place by push notification.

In the present embodiment, a candidate(s) to be used as a parking place may be determined based on the status of vacancy of a plurality of parking spaces.

With this configuration, the parking lot management server 100 is able to, specifically, acquire the status of congestion in the parking lot as a whole based on the status of vacancy of a plurality of parking spaces and inform a user of a candidate(s) to be used as a parking place according to the status of congestion in the parking lot as a whole.

In the present embodiment, a candidate(s) to be used as a parking place may be determined based on the status of congestion of vehicles moving in a parking lot.

With this configuration, the parking lot management server 100 is able to, specifically, acquire the status of congestion in the parking lot as a whole based on the status of congestion of vehicles moving in the parking lot and inform a user of a candidate(s) to be used as a parking place according to the status of congestion of the parking lot as a whole.

In the present embodiment, a candidate(s) to be used as a parking place may be determined based on at least one of the number, gender, and age of occupants in a vehicle of a user.

According to this embodiment, the management server is able to, for example, when the number of occupants in a vehicle is relatively large, inform a user of a candidate(s) to be used as a parking place such that the candidate(s) is/are relatively close to an exit for persons from a parking lot. This is because many people moving in a parking lot cause congestion of moving vehicles and relatively increase safety risks. The parking lot management server 100 is able to, for example, inform a user of a different candidate(s) to be used as a parking place between when the ratio of women in occupants is relatively high and when the ratio of men in occupants is relatively high. This is because, in the case of a parking lot of a facility, such as a shopping mall, destinations in the facility of women users are mostly different from destinations in the facility of men users. The parking lot management server 100 is able to, for example, when occupants include an infant or an elderly person, inform a user of a candidate(s) to be used as a parking place such that the candidate(s) is/are relatively close to an exit for people from a parking lot or an entrance of a facility with the parking lot. Thus, the parking lot management server 100 is able to further improve the convenience of a user.

In the present embodiment, the predetermined incentive may be determined such that the details of the predetermined incentive in a case where a distance from the candidate(s) to be used as a parking place to at least one of an entrance of the parking lot, an exit of the parking lot, and an entrance of a facility with the parking lot is relatively short is different from the details of the predetermined incentive in a case where the distance is relatively long.

With this configuration, even when the parking lot management server 100 guides a vehicle of a user to a parking place whose distance from an entrance or exit of a parking lot, an entrance of a facility with the parking lot, or the like, is relatively long, a sense of unfairness that the user feels is reduced.

In the present embodiment, the details of the predetermined incentive may be determined based on at least one of the number, gender, and age of occupants in the vehicle of the user.

With this configuration, the parking lot management server 100 is able to prepare an incentive to a user of a vehicle such that an advantage of a guide to a designated parking space to be informed to the user relatively increases according to the number, gender, age, or the like, of occupants in the vehicle. Thus, the parking lot management server 100 is able to further relieve congestion in a parking lot.

In the present embodiment, the coupon activation unit 1008 may activate a predetermined coupon into an available state as an incentive that is provided on a parking ticket to be issued at the entrance of a parking lot.

With this configuration, the parking lot management server 100 is able to specifically provide an incentive to a user.

An incentive other than a coupon that is provided on a parking ticket may be provided to a user. For example, a predetermined coupon as an incentive may be distributed to a user terminal of a user. Alternatively, reward points as the predetermined incentive may be added to a reward point balance of a predetermined reward point program, associated with user identification information of the user.

The embodiment of the disclosure is described in detail; however, the disclosure is not limited to the above-described specific embodiment. Various modifications or improvements are applicable within the scope of the purport of the disclosure described in the appended claims.

For example, in the above-described embodiment, part of the functions of the parking lot management server 100 may be provided outside the parking lot management server 100. Specifically, at least one of the function of the entry vehicle detection unit 1003 and the function of the number plate recognition unit 1004 may be transferred to the cameras 30. The function of the ticket issuance control unit 1007 may be transferred to the entrance machine 10. The function of the parking place determining unit 1005, the function of the coupon determining unit 1006, the function of informing a candidate(s) to be used as a parking place in the ticket issuance control unit 1007, and the function of the coupon activation unit 1008 may be transferred to a mobile terminal (an example of an information processing apparatus), such as a smartphone and a tablet terminal, which is carried by a user who desires to use a parking lot. In this case, the mobile terminal of the user and the parking lot management server 100 are communicably connected through the communication network NW, or the like, and resource information required for the function of the parking place determining unit 1005 and the function of the coupon determining unit 1006 is distributed from the parking lot management server 100 to the mobile terminal. The coupon activation unit 1008 may activate a coupon by displaying the coupon on a display of the mobile terminal.

What is claimed is:

1. An information processing apparatus comprising:
an informing unit configured to inform a user, who desires to use a parking lot having a plurality of parking spaces, of a candidate to be used as a parking place from among the plurality of parking spaces through a predetermined informing device; and
an incentive provision unit configured to, when a vehicle of the user is parked in a parking space corresponding to the candidate to be used as a parking place, execute a process for providing a predetermined incentive to the user.

2. The information processing apparatus according to claim 1, wherein the candidate to be used as a parking place is determined based on a status of vacancy of the plurality of parking spaces.

3. The information processing apparatus according to claim 1, wherein the candidate to be used as a parking place is determined based on a status of congestion of vehicles moving in the parking lot.

4. The information processing apparatus according to claim 1, wherein the candidate to be used as a parking place is determined based on at least one of the number, gender, and age of occupants in the vehicle of the user.

5. The information processing apparatus according to claim 1, wherein the predetermined incentive is determined such that details of the predetermined incentive in a case where a distance from the candidate to be used as a parking place to at least one of an entrance of the parking lot, an exit of the parking lot, and an entrance of a facility with the parking lot is relatively short is different from details of the predetermined incentive in a case where the distance is relatively long.

6. The information processing apparatus according to claim 1, wherein details of the predetermined incentive are determined based on at least one of the number, gender, and age of occupants of the vehicle of the user.

7. The information processing apparatus according to claim 1, wherein the incentive provision unit is configured to activate a predetermined coupon into an available state as the predetermined incentive, the predetermined coupon being provided on a parking ticket that is issued at an entrance of the parking lot, cause a user terminal of the user to display a predetermined coupon as the predetermined incentive, or add reward points as the predetermined incentive to a reward point balance of a predetermined reward point program, associated with user identification information of the user.

8. An information processing method that is executed by an information processing apparatus, the information processing method comprising:
a step of informing a user, who desires to use a parking lot having a plurality of parking spaces, of a candidate to be used as a parking place from among the plurality of parking spaces through a predetermined informing device; and
a step of, when a vehicle of the user is parked in a parking space corresponding to the candidate to be used as a parking place, execute a process for providing a predetermined incentive to the user.

9. A program causing an information processing apparatus to execute instructions for:
a step of informing a user, who desires to use a parking lot having a plurality of parking spaces, of a candidate to be used as a parking place from among the plurality of parking spaces through a predetermined informing device; and
a step of, when a vehicle of the user is parked in a parking space corresponding to the candidate to be used as a parking place, execute a process for providing a predetermined incentive to the user.
